(19) United States
(12) Patent Application Publication
(10) Pub. No.: US 2024/0022690 A1
(43) Pub. Date: Jan. 18, 2024

(54) METHOD FOR OPERATING THE SURVEILLANCE NETWORK, COMPUTER PROGRAM AND SURVEILLANCE NETWORK

(71) Applicant: Robert Bosch GmbH, Stuttgart (DE)

(72) Inventor: Mark den Hartog, VW Eindhoven (NL)

(21) Appl. No.: 18/255,139

(22) PCT Filed: Dec. 2, 2020
(86) PCT No.: PCT/EP2020/084242

§ 371 Date: May 31, 2023

(51) Int. Cl. H04N 7/18; H04L 41/14; H04N 23/661

(52) U.S. Cl. CPC H04N 7/181; H04L 41/145; H04N 23/661

(57) ABSTRACT

Method for operating a surveillance network (10), wherein the surveillance network (10) comprises a plurality of network devices (12), wherein the network devices (12) are distributed arranged for monitoring a surveillance area (2), wherein each of the network devices (12) respectively collect surveillance data, wherein at least one network devices (12) forms a surveillance camera (8), wherein the surveillance network (10) is described by an network model, wherein the network model comprises a plurality of network model parameters,wherein the network devices (12) are connected for exchanging device data, wherein the network devices (12) collect for at least one joint event in the surveillance area (2) surveillance data, wherein the network model parameters are determined and/or optimized based on the surveillance data of the joint event.

### BACKGROUND

This invention is related to a method, computer program and surveillance network, wherein the surveillance network comprises a plurality of network devices and at least one surveillance camera.

Surveillance networks are widely used in private and in public places. Surveillance networks are normally comprising several network devices, like sensors and cameras, to monitor for a surveillance area. In most applications it is needed to have some sense of the device physical properties, like knowing, real-time position and pose of the devices. The accuracy required is highly dependent on the use specific application. For example for an object tracking knowing the position and pose with an accuracy of 1 cm is more than sufficient. Therefore a simple calibration of the camera at installing time is sufficient for this application. Other scenarios, for example 3-D image reconstruction or electronic image stabilisation, require a much higher degree of accuracy. Generally, a complex intrinsic, extrinsic system model combined with the real-time sensor input is required.

To model the effects of mechanical and/or other external physical influences on the network devices is complicated. For example, one could model the mechanical behaviour of a single device using traditional system identification. But if one wants to share this state with other devices in the network, one has to take into account the mechanical properties of the system formed by all physical components. Given the high variation in installation environments, for example mounting on walls or moving sensors, using mechanical modelling approaches become useless.

### SUMMARY

This invention relates to a method for operating a surveillance network. Furthermore, this invention relates to computer program and a surveillance network.

The invention concerns a method for operating a surveillance network. Especially, the method is for operating the surveillance network, whereby operation may also comprise an initialising of the surveillance network, a learning and/or training of the surveillance network. The surveillance network comprises a plurality of network devices. Especially, the surveillance network comprises at least 100, preferably at least 1000 network devices. The surveillance network is for example Internet of things network. The surveillance network is preferably for at camera based surveillance. The network devices are Internet of things devices. The different network devices can be devices of the same type or different types, for example different sensors and/or cameras.

The network devices are distributed arranged for monitoring a surveillance area. The surveillance area is for example an indoor area, preferably a public area like an airport or train station. Alternatively, the surveillance area can be an outdoor area, for example or street or a park. For example, the surveillance network is for CCTV surveillance. The network devices are adapted and/or configured to measure, collect and/or provide surveillance. The surveillance data is for example a collected and/or measured physical, chemical or mechanical quantity. The network devices are for example arranged and/or mounted at different places in the surveillance area, to measure the same or different physical, chemical or mechanical quantity. The collected surveillance data are for example temperature, light intensity, inertial forces, optical, electrical thermal or a mechanical quantities. For example, the same physical quantity, e.g. temperature, velocity, size or optical appearance, is measured with different network devices at different places in the surveillance area. At least one of the network devices for a surveillance camera. Preferably at least 30%, more preferably at least 50%, of the network devices are surveillance cameras. Especially, for the surveillance camera the surveillance data are or comprise pictures of at least a part of the surveillance area or the complete surveillance area.

The surveillance network is described, parametrized and/or controlled by an network model. The network model is configured and/or adapted to describe, model and/or control the system behaviour of the surveillance network. The network model for example, especially the network model, comprises or defines a global time and/or a global coordinate system. Especially, the network model comprises the spatial arrangement, distances and/or device description of the network devices. The network model comprises and/or is defined by a plurality of network model parameters. The network model with all network model parameters is for example configured tp described the surveillance network and its devices and/or to describe, understand and/or evaluate, analyse and/or interpret events in the surveillance area.

The network devices are connected for exchanging device data. The network devices may be connected by a wire or may connected wireless. The connection may be a direct connection between devices. Alternatively and/or additionally, the connection between network devices may be indirect, for example a network device can exchange device data with another network devices using a network device between them. The device data may also be provided to a central point. The exchange device data may comprise the surveillance data.

For at least one joint event, especially for more joint events, in the surveillance area surveillance data are taken, collected and/or provided by the network devices. The joint event is for example an event that is possible to be monitored by all network devices. Furthermore, more than one joint event in the surveillance area is monitored by the network devices, wherein the joint events have an overlap. This means for example, that all network devices are collecting surveillance data and/or are monitoring at least one joint event together. The joint event may be physical, mechanical, optical or chemical event, especially a real event, in the surveillance area. Especially, the joint event is for example moving object, person or structured light. The surveillance data taken by the network devices for the joint event are describing the same event.

The network model parameters are determined, computed, estimated and/or optimised based on the surveillance data of the joint event. Especially, the network model is trained, optimised and/or computed based on the surveillance data of the joint event. Especially, up optimisation is a global optimisation of the surveillance network and/or the network model, preferably with boundary conditions on the network devices. The determination and/or optimisation of the network model parameters is preferably based on an agreement on the joint event and/or on measurements, that are collected for the joint event.

The method is based on the idea of an autonomous full system identification based on taking a measurement or more measurements for one or more than one joint event. By agreement on the joint event and especially by the determination and optimisation of the network model parameters it is possible to set a global reference point, for example for having a reverence time and/or reference clock and/or metric.

The network model could be used to improve estimation of physical parameters, for example poses, position or electric quantities, of any individual network device in the network. This allows the network devices to estimate their own transfer function and state with respect to some global reference point and/or the transfer function and state with respect to any other device in the network. For example, the network model could also be used to visualise the connected devices and/or used for generating a digital twin.

Preferably, the device data comprise the surveillance data, especially the surveillance data off in the particular providing network device. Furthermore, the device data comprise for example intrinsic device data, device information and/or additional device data. The intrinsic device data for example describes the type of network device, for example sensor type, measured value, timing information and/or statistical information of the network devices measurement. The device information for example comprises the time and/or clock, serial number and/or connections to other devices. Additional device data are for example a latency of the network device, an accuracy of measurement, stochastic properties of the network device, for example uncertainty of measurement and/or uncertainty in time sampling. Preferably, the device data comprise a full ranking covariance matrix with all measurements, to express the measurement uncertainty. Especially, the device data comprise intrinsic device parameters like intrinsic, parameters, for example to prevent the system needing to cover known parameters and/or correlations. Furthermore, this has the benefit that no nonlinearities have to be removed from the network model. The device data may also comprise a shared world model concept to give semantic information and/or semantic meaning to exchanged data. The device data may also comprise a shared data exchanged model, including the semantic meaning of exchange data.

For example, the surveillance camera and/or a plurality of network devices collect pictures as surveillance data. Preferably, a plurality of surveillance cameras collect a plurality of pictures as surveillance data. Pictures taken as the surveillance data for the joint event show at least a part of the joint event. A feature extraction as applied to the pictures and/or the surveillance data. Based on the extracted and/or detected features the network model parameters are determined and/or optimised. For example, the surveillance data and/or the pictures, show the joint event, for example a specific object with unique shape and/or structure. By agreeing and/or comparing the detected feature the network model parameters are determined and/or optimised. This embodiment is based on the idea that taking surveillance data and pictures with the network devices and preferably use a feature extraction the network model parameters can be determined. The joint event shown and/or captured by the picture can be a static or a moving object, especially knowing the velocity and path of the moving object.

Preferably, the network devices are adding a timestamp to their device data. The timestamp is especially based on the time reverence and/or clock of the particular network device. For example, each network device has its own time reverence and/or clock. More preferably, the network devices are able and/or configured to adapt their clock and/or reference time according to a global time. Especially the timestamp has an uncertainty, wherein the uncertainty is comprised and or stated in the device data.

Preferably, the network device and/or devices are configured to adjust their device time and/or clock. Furthermore, the network device and/or devices are preferably configured to determine a time difference between their device time and/or clock to a device time of another device or the global time of the network. The determination of the time difference and/or the adjustment of the device time is preferably based on the device data, the network model and/or the surveillance data. For example, by agreeing on an event monitored by two devices and/or by agreeing on the joint event the devices are able to adjust their device time. Especially, the adjustment and/or the termination of time difference and/or device time is based on given and/or known spatial distances of devices, for example provided by the network model.

The network model parameters for example comprise a physical device parameter, wherein the physical device parameter is especially linked to the particular network device. The physical device parameter for example comprise pose, position, state and/or a focus of the network device, especially of the camera.

According to preferred embodiment of the invention, the network device and/or the network devices are configured to determine their transfer function with respect to another network device, a global reference point and/or to a configurable reference point. By knowing and optimisation of the network model and the determination of the network model parameters the network devices can determine their transfer function with respect to another device or the global reference point. The network model for example comprises information about a global time and/or of spatial distances of the network devices in the network, whereby the network devices can determine their transfer function based on the network model in a global or relative way to another device.

Preferably, based on the network model and/or based on the network model parameters a digital twin or a visualization of the surveillance network determined, computed and/or generated. For example the network model comprises the information about the spatial arrangement of the network devices and comprises their state, prose, position and/or focus, whereby each state at any time of the network and/or the network devices can be visualised and/or described with the digital twin.

Preferably, each of the network devices has a detection area for collecting the surveillance data. The detection area is especially part of the surveillance area. Preferably, all or a part of adjacent devices are arranged with an overlap of the detection area. Preferably, these network devices are arranged that each of the network devices has at least one overlap with one adjacent network device. Based on the surveillance data of devices with an overlapping detection area correlations are determined and/or the network model parameters are determined.

Preferably the joint event is generated as an artificial event. For example, the joint event is an artificial signal, for example an optical signal. The artificial signal may be generated by a structured light source, a vibrating or time changing optical or mechanical device. The artificial signal is preferably generated in the whole surveillance area, especially at the same time.

Optionally, the determined and/or optimised network model parameters are set for the network model and/or for running the surveillance network. For example, the determination and optimisation of the network model parameters is performed by the initialisation of the surveillance network. Especially the determination and/or optimisation of the network model parameters is performed when a new network device is integrated or a network device is replaced by another network device. After the determination and/or optimisation of the network model parameters they are set and/or fixed, where with the set and/or fixed network model parameters the network model is completely described and usable to describe any state or behaviour of the surveillance network and/or of the network device of the surveillance network.

Preferably, the network devices are configured to update their local state based on the network model and based on their surveillance data or commended by exchange device data. For example, the devices are configured to dynamically update their local state based on the network model and based on their surveillance data by augmentation of their exchange device data. Especially, the network device is configured to update their local state, for example clock or transfer function, by augmenting its device data and/or it surveillance data with an adjacent network device.

Preferably, the network model and/or the network model parameters are updated dynamically. The updating of the local state and/or the updating of the network model is especially decentralised and/or prepared by all or a part of the network devices. Especially, a learning and/or machine learning of the optimisation and/or determination of the network model parameters may be performed central, for example on a central computer.

A further object of the invention forms a computer program. The computer program is configured to be run on a computer or any networked device of the surveillance network. The computer program is configured to perform and/or run the methods for operating the surveillance network, especially as described before.

A further object of the invention is a surveillance network. The surveillance network comprises a plurality of network devices, especially as described before. At least one of the network devices is a surveillance camera. The network devices and the surveillance camera are configured as described before. The network devices are connected for exchanging device data. The surveillance network and/or the arrangement of the network devices in the surveillance network is describable by the network model, where by the network model comprises a plurality of the network model parameters, especially as described before. The surveillance network, especially the network devices, are configured to determine and/or optimise the network model parameters based on surveillance data taken for a joint event in the surveillance area. After determination and/or optimisation of the network model parameters the network model is for example run with the determined and/or optimised network model parameters.

### BRIEF DESCRIPTION OF THE DRAWINGS

Further embodiments, advantages and/or effects are shown in the figures and their description. Thereby it is shown:

FIG. 1 a schematic example of a surveillance network;

FIG. 2 a network model for the surveillance network of FIG. 1,

FIG. 3 a flow chart for an execution example of the method for operating a surveillance network.

### DETAILED DESCRIPTION

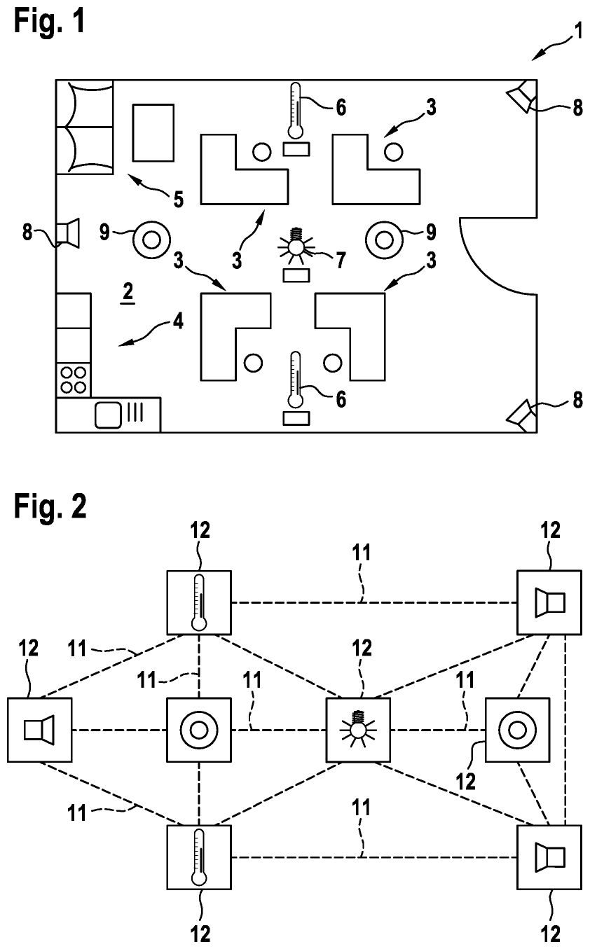

FIG. 1 shows schematically a spatial planning 1 of room 2 as surveillance area. The room 2 is an open-plan office with several desks 3, a kitchen unit 4 and a seat group 5. The room 2 is air-conditioned and has controlled lighting. Temperature sensors 6 are installed in the room to control the air conditioning. At least one brightness sensor 7 is installed in the room 2 to control the lighting. Furthermore, the office is monitored by video surveillance, whereby surveillance cameras 8 are installed in the room 2. For fire protection, fire alarms 9 are distributed throughout the office. The temperature sensors 6, light sensors 7, surveillance cameras 8 and fire detectors 9 form network devices of a surveillance network 10.

FIG. 2 shows a graph of the surveillance network 10 with connections 11. The network devices 12, here 6, 7, 8 and 9, connected for an exchange of device data. The network devices partly directly connected, e.g., by the connections 11, and partly indirectly connected to exchange the device data via another network device. The surveillance network 10 is described by an network model, wherein the network model is based and/or comprises a plurality of network model parameters. The network model can be based on a linear spring model and/or a swarm model. The network model with determined and/or optimised network model parameter is adapted to describe, determine and/or estimate the state, behaviour, pose and/or position of any network device in the surveillance network 10.

The device data exchanged by the network device may contain the state, position, device time, pose, functions, measurement uncertainties, intrinsic and/or extrinsic data of the particular network device. In the room 2 a joint event is triggered and/or produced. The joint event, at least a part of the joint event and/or a consequence of the joint event is monitored and/or captured as surveillance data of each of the network devices. The surveillance data are especially part of the exchanged device data. Based on the surveillance data taken by the network devices for the joint event all network model parameters are determined, computed and/or optimised.

For example a lightening event of structured light with a significant infrared and/or thermal radiation part is produced in the room. The lightning event is the joint event that is detected by all network devices. For example the surveillance camera 8, the brightness sensor land the fire detector 9 with photo diode detects the light of the joint event directly. The thermal sensor 6 detect the thermal radiation as consequence of the joint event. By agreeing on a happening of the joint event at the same time, ignoring the minimal time delay caused by the finite speed of light, the network model parameter can be determined and/or optimized. Furthermore the pictures taken by the surveillance camera are analysed using feature detection, whereby poses, positions and/or states of the other network devices in the surveillance network are extracted and used for determining and/or optimizing the network model parameters.

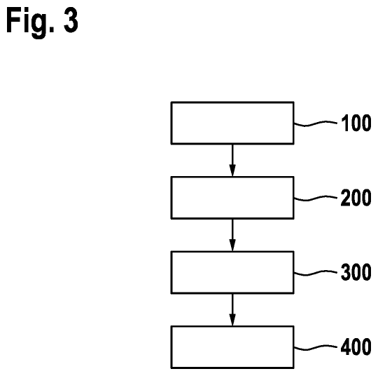

FIG. 3 shows a flow chart of for an example of the method for running the surveillance network 10. In a step 100 the network devices are arranged and/or mounted in the room 2. Furthermore, the network devices are linked and/or connected for the exchange of device data.

In step 200 a joint event is produced, for example as lightening event as described for FIG. 2. The joint event can also comprise several sub events, like moving objects, electrical, optical and/or mechanical processes that can be measured and/or monitored by the network devices. For the joint event and/or the subevents surveillance data are taken by the network devices.

In step 300 the network model parameters are determined and/or optimized. Preferably, they are determined and/or optimized decentral for example distributed to the network devices. By agreeing on the happening of the joint event at the same time and/or or at the same position for all network devices, or by knowing the time and/or position translation, the network model parameters are determined and/or optimized.

In step 400 the determined and/or optimized network model parameters are set for running the network model in routine operation. With set network model parameters any event and/or any state of a network device can be estimated and/or determined. Especially, the network model with the set network model parameters may be used by the devices to determine a time shift of its own device time relative to global time or any other device time.

1. A method for operating a surveillance network (10), wherein the surveillance network (10) comprises a plurality of network devices (12), wherein the network devices (12) are arranged for monitoring a surveillance area (2), wherein each of the network devices (12) respectively collect surveillance data, wherein at least one network devices (12) forms a surveillance camera (8),
wherein the surveillance network (10) is described by a network model, wherein the network model comprises a plurality of network model parameters,
wherein the network devices (12) are connected for exchanging device data,
wherein the network devices (12) collect for at least one joint event in the surveillance area (2) surveillance data,
wherein the network model parameters are determined and/or optimized based on the surveillance data of the joint event.

2. The method according to claim 1, wherein the device data comprise the surveillance data, intrinsic device data, device information and/or additional device data, wherein the network model parameters are determined and/or optimized based on device data.

3. The method according to claim 1, wherein the surveillance camera (8) collects pictures as surveillance data, wherein features are detected in the picture, wherein the network model parameters are determined and/or optimized based on the detected features.

4. The method according to claim 1, wherein the network devices (12) are adding a time-stamp to their device data.

5. The method according to claim 1, wherein the network devices (12) are configured to adjust their device time and/or determine a time difference between their device time and a device time of another network device (12) in the surveillance network (10) based on the device data and/or the surveillance data.

6. The method according to claim 1, wherein the network model parameters comprise physical device parameter, wherein the physical device parameter comprise pose, position, temperature and/or focus of the network devices (10).

7. The method according to claim 1, wherein the network devices (12) determine their transfer function with respect to another network device (12) and/or a global reference point based on the network model.

8. The method according to claim 1, wherein based on the network model and/or the network model parameters a digital twin and/or a visualisation of the surveillance network (10) is determined.

9. The method according to claim 1, wherein each of the network devices (12) has a detection area for collecting the surveillance data, wherein adjacent network devices (12) are arranged with an overlap of their detection areas, wherein correlations are determined based on surveillance data of network devices (12) with an overlapping detection area.

10. The method according to claim 1, wherein the joint event is generated as artificial signal.

11. The method according to claim 1, wherein the determined and/or optimized network model parameters are set for the network model and/or running the surveillance network (10).

12. The method according to claim 11, wherein the network devices (12) are configured to update their local state based on the network model and/or based on their surveillance data augment by exchanged device data.

13. The method according to claim 1, wherein updating the local state and/or updating the network model is decentralized.

14. A non-transitory, computer-readable medium containing instructions that when executed by the computer cause the computer operate a surveillance network (10), wherein the surveillance network (10) comprises a plurality of network devices (12), wherein the network devices (12) are arranged for monitoring a surveillance area (2), wherein each of the network devices (12) respectively collect surveillance data, wherein at least one network devices (12) forms a surveillance camera (8),
wherein the surveillance network (10) is described by a network model, wherein the network model comprises a plurality of network model parameters,
wherein the network devices (12) are connected for exchanging device data,
wherein the network devices (12) collect for at least one joint event in the surveillance area (2) surveillance data,
wherein the network model parameters are determined and/or optimized based on the surveillance data of the joint event.

15. A surveillance network (12) with network devices (12) configured for running the method according to claim 1.
